(19) United States
(12) Patent Application Publication
(10) Pub. No.: US 2024/0174044 A1
(43) Pub. Date: May 30, 2024

(54) AIR CONDITIONER FOR VEHICLE

(71) Applicants: Hyundai Motor Company, Seoul (KR); Kia Corporation, Seoul (KR); Hanon Systems, Daejeon (KR)

(72) Inventors: Eung Young KIM, Anyang-Si (KR); Myung Hoe KIM, Seoul (KR); Yoon Hyung LEE, Seongnam-Si (KR); Seung Ho LEE, Daejeon (KR); Sang Ki LEE, Daejeon (KR); Dae Bok KEON, Daejeon (KR); Dae Keun PARK, Daejeon (KR); Hyeon Seok KIM, Daejeon (KR)

(73) Assignees: Hyundai Motor Company, Seoul (KR); Kia Corporation, Seoul (KR); Hanon Systems, Daejeon (KR)

(21) Appl. No.: 18/511,712

(22) Filed: Nov. 16, 2023

(30) Foreign Application Priority Data
Nov. 28, 2022 (KR) 10-2022-0161574

(51) Int. Cl. B60H 1/00; B60H 1/32; B60S 1/54

(52) U.S. Cl. CPC B60H 1/00028; B60H 1/0005; B60H 1/323; B60S 1/54; B60H 2001/00092

(57) ABSTRACT

An air conditioner for a vehicle capable of preventing a situation in which an occupant's head gets hot by improving a vertical temperature difference between a defrost vent and a floor vent, includes an air conditioning case in which an air flow path is formed, and a cooling heat exchanger and a heating heat exchanger provided sequentially on the air flow path of the air conditioning case in an airflow direction, wherein a defrost vent, a face vent, and a floor vent are formed on the air conditioning case, wherein a hot air duct configured to allow hot air at a downstream side of the heating heat exchanger to flow to an outlet of the floor vent is provided on the air conditioning case.

### CROSS REFERENCE TO RELATED APPLICATION

The present application claims priority to Korean Patent Application No. 10-2022-0161574, filed Nov. 28, 2022, the entire contents of which is incorporated herein for all purposes by this reference.

### BACKGROUND OF THE PRESENT DISCLOSURE

### Field of the Present Disclosure

The present disclosure relates to an air conditioner for a vehicle, and more specifically, to an air conditioner for a vehicle in which heat exchangers for performing cooling and heating are laid horizontally.

### DESCRIPTION OF RELATED ART

Generally, an air conditioner for a vehicle is an internal part of a vehicle which is installed to cool or heat a vehicle interior in summer or winter or secure a driver's forward and backward field of views by removing frost or the like sticking to a windshield in rainy weather or winter. The air conditioner usually has both a heating system and a cooling system, and thus selectively introduces outside air or inside air to heat or cool the air, and then blow the outside air or the inside air into the vehicle interior to cool, heat, or ventilate the vehicle interior.

Among various types of air conditioners for a vehicle, there is a slim type air conditioner in which heat exchangers are provided to be laid horizontally. FIG. 1 is a cross-sectional view exemplarily illustrating a conventional air conditioner for a vehicle with horizontally-disposed heat exchangers.

Referring to FIG. 1, the conventional air conditioner for a vehicle includes an air conditioning case 10 on which an air inlet 23 is formed at the bottom thereof, an evaporator 11 that is a cooling heat exchanger, and an indoor condenser 13 that is a heating heat exchanger. The evaporator 11 and the indoor condenser 13 are sequentially provided inside the air conditioning case 10 in an airflow direction. An electric heater 14, such as a positive temperature coefficient (PTC) heater, is provided at a downstream side of the indoor condenser 13 in an airflow direction.

The evaporator 11, the indoor condenser 13, and the electric heater 14, which are heat exchangers, are all disposed to be laid horizontally. In other words, air flows into the air inlet 23 at the bottom of the air conditioning case 10 to flow from the bottom to the top, and the evaporator 11, the indoor condenser 13, and the electric heater 14 are disposed sequentially from the bottom. A temperature door 12 is provided between the evaporator 11 and the indoor condenser 13.

The temperature door 12 adjusts a temperature of the vehicle interior by adjusting an opening degree of a hot air passage through which air passes through the indoor condenser 13 and a cooling air passage through which air bypasses the indoor condenser 13. A plurality of air outlets are formed on the air conditioning case 10. The air outlet includes a defrost vent 20, a face vent 19, a floor vent 18, and a rear seat vent 24. The defrost vent 20, the face vent 19, and the floor vent 18 discharge air to front seats of the vehicle, and the rear seat vent 24 includes a console, a B-pillar, a rear seat floor vent, and the like.

In addition, a plurality of doors for adjusting an opening degree of the air outlet is provided in the air conditioning case 10. In other words, a defogging door 17 for adjusting an opening degree of the defrost vent 20, a vent door 16 for adjusting an opening degree of the face vent 19, a floor door 15 for adjusting an opening degree of the floor vent 18, and rear seat doors 21 and 22 for adjusting an opening degree of the rear seat vent 24 are provided in the air conditioning case 10.

Further referring to FIG. 2, in the case of a mode in which both the defrost vent 20 and the floor vent 18 are opened, such as a floor mode or a mix mode, hot air coming from the defrost vent 20 blows on occupant's face, causing dissatisfaction. This is because an outlet of the defrost vent 20 is disposed directly above the heating heat exchanger due to a structure of the horizontally-disposed heat exchangers. In addition, hot air is directly discharged to the interior through the defrost vent 20, making it difficult to satisfy the criterion in which a temperature at the floor vent 18 side should be higher than a temperature at the defrost vent 20 side.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an air conditioner for a vehicle configured for preventing a situation in which an occupant's head gets hot by improving a vertical temperature difference between a defrost vent and a floor vent.

An air conditioner for a vehicle according to an exemplary embodiment of the present disclosure including an air conditioning case in which an air flow path is formed, and a cooling heat exchanger and a heating heat exchanger provided sequentially on the air flow path of the air conditioning case in an airflow direction, wherein a defrost vent, a face vent, and a floor vent are formed on the air conditioning case, wherein a hot air duct configured to allow heated air at a downstream side of the heating heat exchanger to flow to an outlet of the floor vent is provided on the air conditioning case.

An internal flow path of the air conditioning case may be formed in a vertical direction with respect to the ground so that the air flow path is directed from a downward direction, which is a direction of gravity, to an upward direction, and the cooling and heating heat exchangers on the internal flow path may include a structure that is sequentially disposed from the downward direction, which is the direction of gravity, to the upward direction in correspondence to the air flow path from the downward direction, which is the direction of gravity, to the upward direction.

The outlet of the floor vent may be formed on a side surface of the air conditioning case, and the hot air duct may be formed on the side surface of the air conditioning case to connect a downstream side of the heating heat exchanger to the outlet of the floor vent.

The air conditioning case may include a hot air guide baffle configured to guide heated air passing through the heating heat exchanger to a cooling air flow path side between the heating heat exchanger and the defrost vent.

The hot air guide baffle may block heated air at the downstream side of the heating heat exchanger from being directly discharged to the defrost vent and guide the heated air to the floor vent.

The hot air guide baffle may be formed to extend to overlap a portion of the hot air duct.

A floor door configured to adjust an opening degree of the floor vent may be provided, and the hot air duct may connect the downstream side of the heating heat exchanger to an upstream side of the floor door.

The hot air duct may be coupled to protrude laterally from the side surface of the air conditioning case, and an inclined surface may be formed on a coupling portion between the hot air duct and the air conditioning case in the airflow direction.

An air conditioner for a vehicle according to another aspect of the prevent invention including an air conditioning case in which an air flow path is formed, and a cooling heat exchanger and a heating heat exchanger provided sequentially on the air flow path of the air conditioning case in an airflow direction, wherein a defrost vent, a face vent, and a floor vent are formed on the air conditioning case, wherein the air conditioning case includes a hot air guide baffle configured to guide heated air passing through the heating heat exchanger to a cooling air flow path side between the heating heat exchanger and the defrost vent.

An internal flow path of the air conditioning case may be formed in a vertical direction with respect to the ground so that the air flow path is directed from a downward direction, which is a direction of gravity, to an upward direction, and the cooling and heating heat exchangers on the internal flow path may include a structure that is sequentially disposed from the downward direction, which is the direction of gravity, to the upward direction in correspondence to the air flow path from the downward direction, which is the direction of gravity, to the upward direction.

The air conditioning case may include a defogging door configured to adjust an opening degree of the defrost vent, and the hot air guide baffle may be formed to extend in a transverse direction to block at least a portion between the heating heat exchanger and the defogging door.

The air conditioning case may include a defogging door configured to adjust an opening degree of the defrost vent, and the hot air guide baffle may extend in the transverse direction between the heating heat exchanger and the defogging door, and one end portion of the hot air guide baffle may extend up to an internal wall of the air conditioning case and the other end portion may extend toward a cooling air flow path, and thus an inside of the air conditioning case may be covered at an opening of the defrost vent.

The air conditioner for a vehicle according to an exemplary embodiment of the present disclosure can prevent the situation in which the occupant's head gets hot by improving the vertical temperature difference between the defrost vent and the floor vent.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side cross-sectional view exemplarily illustrating a conventional air conditioner for a vehicle with horizontally-disposed heat exchangers.

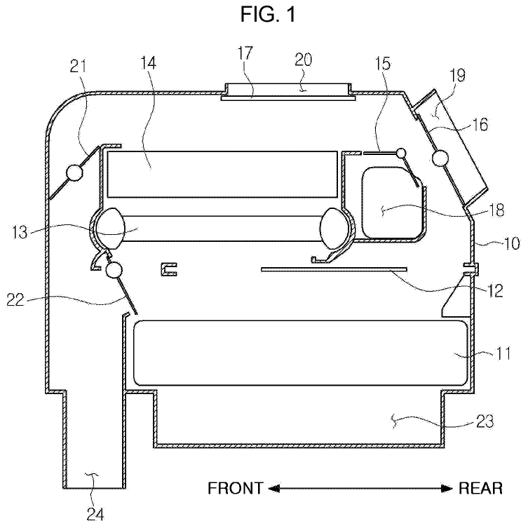

FIG. 2 is a view exemplarily illustrating an operation example of FIG. 1.

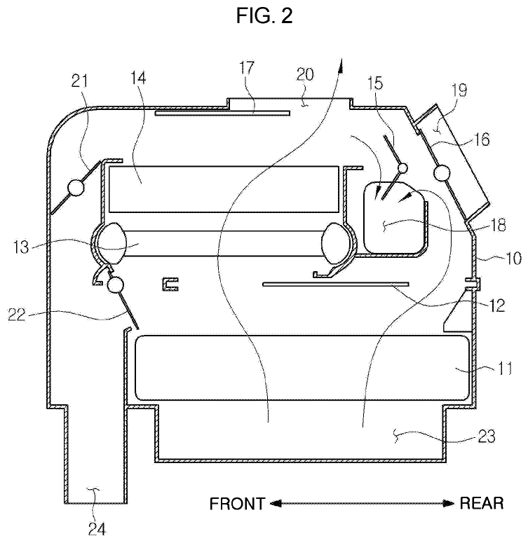

FIG. 3 is a side cross-sectional view exemplarily illustrating an air conditioner for a vehicle according to various exemplary embodiments of the present disclosure.

FIG. 4 is a perspective view exemplarily illustrating a portion of an outside of an air conditioning case on which a hot air duct according to various exemplary embodiments of the present disclosure is provided.

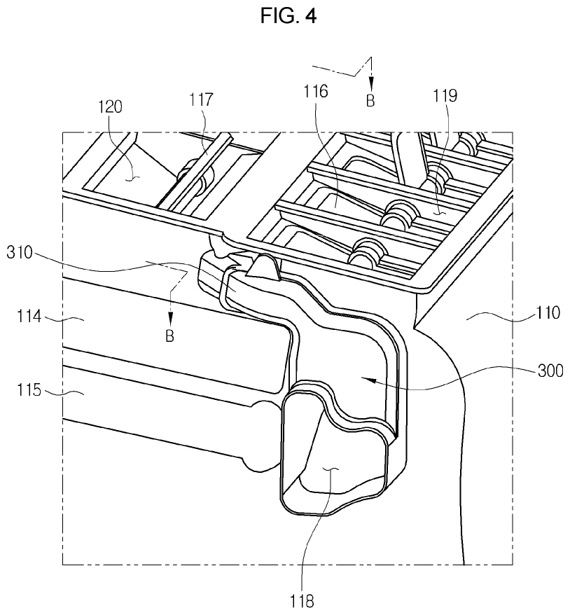

FIG. 5 is a side view exemplarily illustrating the air conditioning case on which the hot air duct according to various exemplary embodiments of the present disclosure is provided.

FIG. 6 is a cross-sectional view along line B-B in FIG. 4.

FIG. 7 is an enlarged view exemplarily illustrating a portion of the air conditioning case in FIG. 5.

FIG. 8 is a view exemplarily illustrating an operation example of the air conditioner for a vehicle according to various exemplary embodiments of the present disclosure.

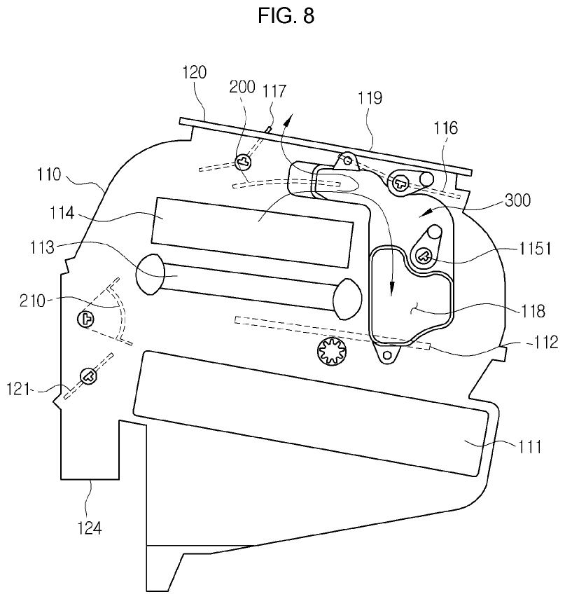

FIG. 9 is a side view exemplarily illustrating an air conditioning case on which a hot air duct according to various exemplary embodiments of the present disclosure is provided.

FIG. 10 is a view exemplarily illustrating an operation example of an air conditioner for a vehicle according to various exemplary embodiments of the present disclosure.

FIG. 11 is a side cross-sectional view exemplarily illustrating an air conditioner for a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a technical configuration of an air conditioner for a vehicle will be described in detail with reference to the accompanying drawings as follows.

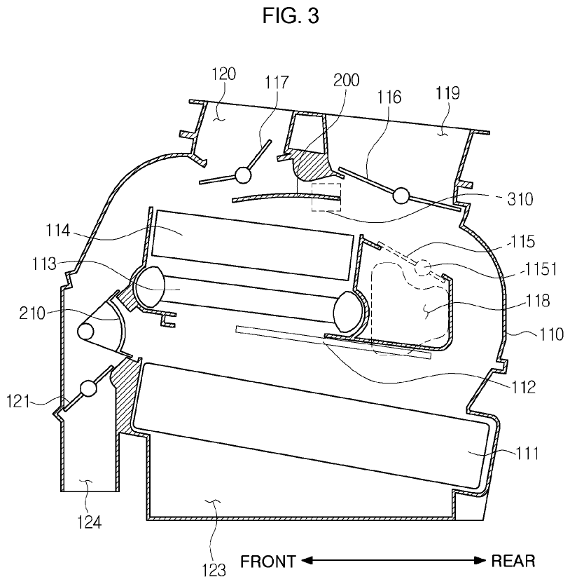

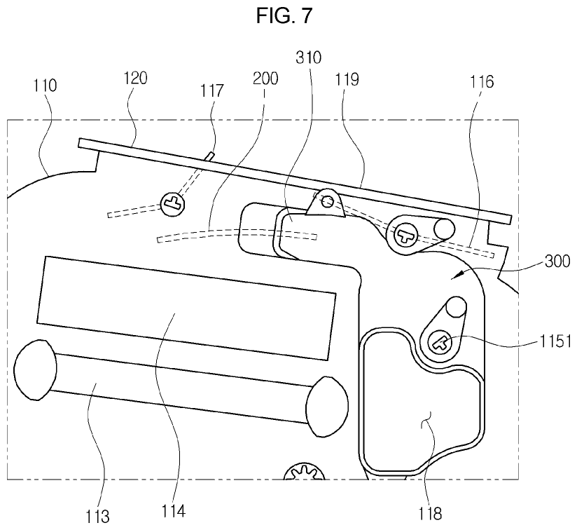

Referring to FIGS. 3 and 7, the air conditioner for a vehicle according to various exemplary embodiments of the present disclosure is a slim type air conditioner formed of a horizontally-disposed heat exchanger type and includes a relatively smaller width in a vertical direction. The air conditioner for a vehicle includes an air conditioning case 110, a cooling heat exchanger and a heating heat exchanger, a hot air guide baffle 200, and a hot air duct 300. In the following description, a left and right direction of FIG. 3 is a front and rear direction of the vehicle.

The air conditioning case 110 includes an air flow path formed therein and is formed of a slim type with a narrow width in the vertical direction. An air inlet 123 and a plurality of air outlets are formed on the air conditioning case 110. A blower unit for blowing air into the air conditioning case 110 is connected to the air inlet 123 of the air conditioning case 110. The blower unit selectively introduces inside air or outside air and blows the inside air or the outside air into the air conditioning case 110.

In addition, the air inlet 123 of the air conditioning case 110 is formed at the bottom portion of the cooling heat exchanger to allow air to flow from a lower portion to an upper portion thereof. The air outlet of the air conditioning case 110 includes a front seat air outlet for discharging air to front seats of the vehicle and a rear seat air outlet for discharging air to rear seats of the vehicle. The front seat air outlet includes a defrost vent 120, a face vent 119, and a floor vent 118, and the rear seat air outlet includes a rear seat vent 124.

The defrost vent 120 is for blowing air toward a window of the vehicle, the face vent 119 is for blowing air toward an occupant's face in the front seat of the vehicle, and the floor vent 118 is for blowing air toward the occupant's feet in the front seat of the vehicle. In addition, the rear seat vent 124 includes a console, a B-pillar, a rear seat floor vent, and the like for a vehicle.

In addition, a plurality of doors for adjusting an opening degree of the air outlet are provided in the air conditioning case 110. In other words, a defogging door 117 for adjusting an opening degree of the defrost vent 120, a vent door 116 for adjusting an opening degree of the face vent 119, a floor door 115 for adjusting an opening degree of the floor vent 118, and a rear seat air volume door 121 for adjusting an opening degree of the rear seat vent 124 are provided in the air conditioning case 110.

The cooling heat exchanger is formed as an evaporator 111, and the heating heat exchanger is formed as an indoor condenser 113. An electric heater 114, such as a positive temperature coefficient (PTC) heater, is provided at a downstream side of the indoor condenser 113 in an airflow direction. The evaporator 111 and the indoor condenser 113 are provided on a refrigerant circulation line connecting a compressor, an expansion valve, and the like and function as a cooler or a heat generator depending on a change in state of refrigerant. In other words, refrigerant passing through the evaporator 111 exchanges heat with the air to cool the air, and refrigerant passing through the indoor condenser 113 exchanges heat with the air to heat the air.

The evaporator 111 and the indoor condenser 113 are sequentially provided on an air flow path of the air conditioning case 110 in the airflow direction. In the instant case, the evaporator 111, the indoor condenser 113, and the electric heater 114, which are heat exchangers, are all disposed to be laid horizontally. In other words, an internal flow path of the air conditioning case 110 is formed in the vertical direction with respect to the ground so that the air flow path is directed from a downward direction, which is a direction of gravity, to an upward direction. In addition, the cooling and heating heat exchangers on the internal flow path include a structure that is sequentially disposed from the downward direction, which is the direction of gravity, to the upward direction in correspondence to the air flow path from the downward direction, which is the direction of gravity, to the upward direction.

As described above, the heat exchangers are disposed horizontally or to be inclined at a certain angle close to horizontality with respect to the ground. In other words, air flows into the air inlet 123 at the bottom portion of the air conditioning case 110 to flow from the bottom to the top, and the evaporator 111, the indoor condenser 113, and the electric heater 114 are disposed sequentially from the bottom portion.

A temperature door 112 is provided between the evaporator 111 and the indoor condenser 113. The temperature door 112 adjusts a temperature of the vehicle interior by adjusting an opening degree of a hot air passage through which air passes through the indoor condenser 113 and a cooling air passage through which air bypasses the indoor condenser 113. In other words, an amount of air passing through the indoor condenser 113 and the electric heater 114 and an amount of air bypassing the indoor condenser 113 and the electric heater 114 are adjusted depending on a position of the temperature door 112. In addition, the air conditioning case 110 includes a rear seat temperature door 210 disposed between the evaporator 111 and the indoor condenser 113 to adjust a temperature of air flowing to the rear seat air outlet.

The temperature door 112 is formed of a plate-shaped door and slides in the horizontal direction in the air conditioning case 110 to adjust an opening degree between the cooling air passage and the hot air passage. The sliding type temperature door 112 greatly helps in slimming a vertical width of the air conditioning case 110. In addition, a separator for partitioning left and right sides in a width direction of the vehicle is provided inside the air conditioning case 110 to perform left and right independent air conditioning of a driver's seat and a passenger's seat in the front of the vehicle.

Meanwhile, the rear seat air outlet is disposed in front of the front seat air outlet. In other words, the rear seat vent 124, which is the rear seat air outlet, is disposed at a front side of the air conditioning case 110, and the defrost vent 120, the face vent 119, and the floor vent 118, which are the front seat air outlets, are all disposed behind the rear seat vent 124. The defrost vent 120 and the face vent 119 are formed on an upper end portion of the air conditioning case 110, and the floor vents 118 are formed on both side surfaces of the air conditioning case 110. In addition, the defrost vent 120 is disposed in front of the face vent 119.

The hot air guide baffle 200 is provided inside the air conditioning case 110 and disposed between the electric heater 114 and the defrost vent 120. The hot air guide baffle 200 is configured to guide the hot air passing through the heating heat exchanger toward the cooling air flow path. In other words, the hot air guide baffle 200 prevents hot air at the downstream side of the heating heat exchanger from being directly discharged to the defrost vent 120 and guides the hot air to the floor vent 118.

The hot air guide baffle 200 is formed to extend in a transverse direction to block at least a portion of a space between the electric heater 114 and the defogging door 117. The hot air guide baffle 200 is formed throughout the inside of the air conditioning case 110 in the width direction of the vehicle. In other words, one end portion of the hot air guide baffle 200 touches a left internal wall of the air conditioning case 110, and the other end portion thereof touches a right internal wall of the air conditioning case 110 in the width direction of the vehicle. The hot air guide baffle 200 may be injection-molded integrally with the air conditioning case 110 or made separately and assembled with the air conditioning case 110.

The hot air passing through the indoor condenser 113 and the electric heater 114 tries to flow to the defrost vent 120 positioned directly thereon, and the hot air guide baffle 200 disposed between the electric heater 114 and the defogging door 117 blocks the hot air trying to go up, and thus the hot air is bypassed and discharged to the defrost vent 120 or guided by the hot air guide baffle 200 to flow to the rear seat vent 124, which is the front side of the vehicle, or flow to the face vent 119 or the floor vent 118, which is the rear side of the vehicle.

The hot air duct 300 is provided outside the air conditioning case 110 and allows the hot air at the downstream side of the heating heat exchanger to flow to an outlet of the floor vent 118. The outlets of the floor vent 118 are formed on both side surfaces of the air conditioning case 110. In addition, the hot air ducts 300 are formed on both side surfaces of the air conditioning case 110 and connects a downstream side of the heating heat exchanger to the outlet of the floor vent 118.

Meanwhile, the hot air duct 300 is provided to connect the downstream side of the heating heat exchanger to an upstream side of the floor door 115. In other words, the hot air duct 300 includes a tubular shape with open both sides, and one side is connected to the downstream side of the electric heater 114 and the other side is connected to the outlet side of the floor vent 118. The hot air duct 300 is provided outside the air conditioning case 110. The hot air duct 300 is coupled to protrude laterally from a side surface of the air conditioning case 110.

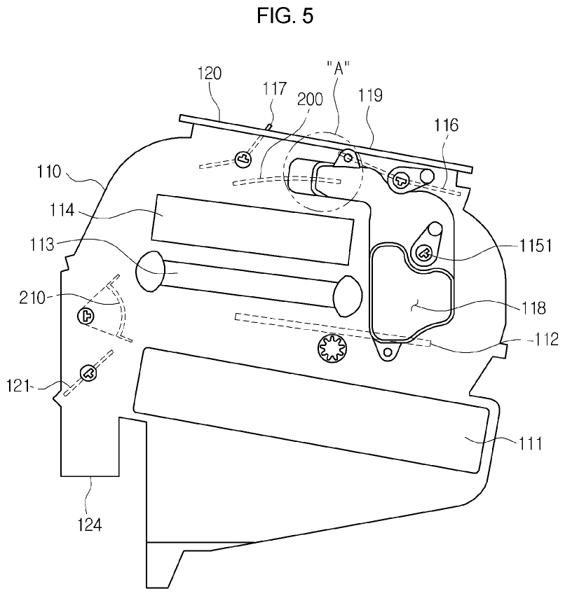

An inclined surface is formed on a coupling portion 310 between the hot air duct 300 and the air conditioning case 110 in the airflow direction. The coupling portion 310 between the hot air duct 300 and the air conditioning case 110 is formed to include an inclined surface so that the hot air passing through the indoor condenser 113 and the electric heater 114 may smoothly flows into the hot air duct 300 and may be discharged to the floor vent 118. In addition, the hot air guide baffle 200 is formed to extend to partially overlap the hot air duct 300 as illustrated in “A” of FIG. 5.

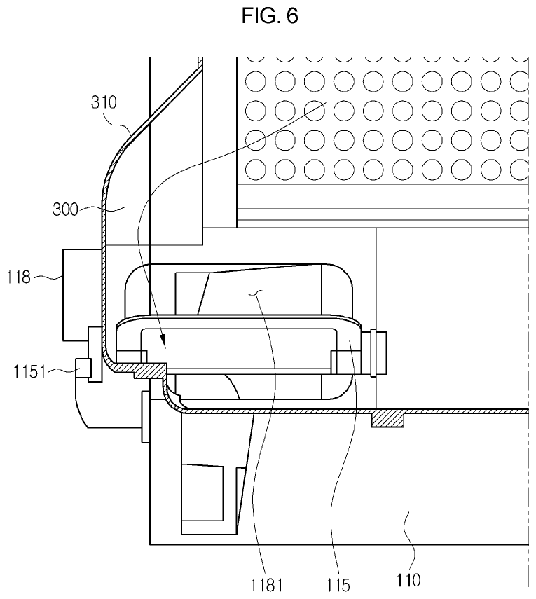

As illustrated in FIG. 6, the air flow path inside the air conditioning case 110 includes an opening 1181 formed at the bottom portion of the face vent 119 for air to flow to the floor vent 118, and the openings 1181 are formed at both sides of the air conditioning case 110 in the width direction of the vehicle. In the instant case, the width direction of the vehicle is a left and right direction in FIG. 6. The opening 1181 is formed to pass through in the vertical direction, and the floor door 115 is rotated about a rotation shaft 1151 using the width direction of the vehicle as an axis to open or close the opening 1181.

As the hot air duct 300 is provided to connect the downstream side of the heating heat exchanger to the upstream side of the floor door 115, the air passing through the hot air duct 300 and all air to be discharged to the floor vent 118 are discharged to the vehicle interior through the floor vent 118 after passing through the opening 1181 by the rotation control of the floor door 115. The hot air duct 300 is not formed inside the air conditioning case 110 and may be formed separately outside the air conditioning case 110 to smoothly guide the hot air passing through the heating heat exchanger to the floor vent 118 while minimizing an air flow resistance.

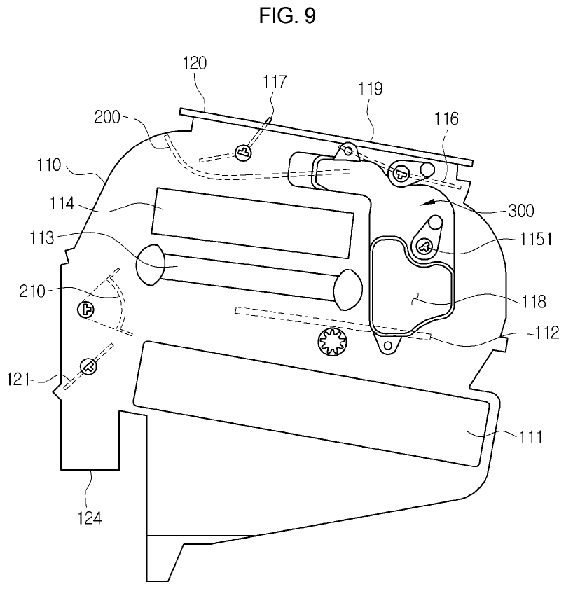

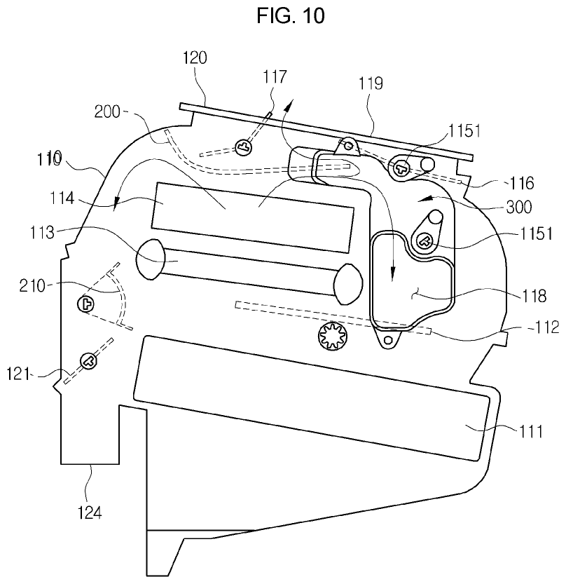

Meanwhile, further referring to FIG. 9 and FIG. 10, an air conditioner for a vehicle according to various exemplary embodiments of the present disclosure may include the hot air guide baffle 200 with a different structure. In other words, the hot air guide baffle 200 according to various exemplary embodiments of the present disclosure extends in a transverse direction between the heating heat exchanger and the defogging door 117. In the instant case, one end portion of the hot air guide baffle 200 extends to the internal wall of the air conditioning case 110, and the other end portion extends toward the cooling air passage.

In addition, the hot air guide baffle 200 is formed throughout the inside of the air conditioning case 110 in the width direction of the vehicle. In other words, one end portion of the hot air guide baffle 200 touches a left internal wall of the air conditioning case 110, and the other end portion thereof touches a right internal wall of the air conditioning case 110 in the width direction of the vehicle. The hot air guide baffle 200 may be injection-molded integrally with the air conditioning case 110 or made separately and assembled with the air conditioning case 110.

As a result, because the inside of the air conditioning case 110 is covered at the opening of the defrost vent 120, the inside of the air conditioning case 110 is covered by the hot air guide baffle 200 when the air conditioning case 110 is viewed from the opening of the defrost vent 120 and is not visible. As described above, by forming the hot air guide baffle 200 in a partition wall structure so that hot air may be guided only in one direction of the outlet of the defrost vent 120, the hot air directly discharged to the defrost vent 120 is fully blocked, increasing an effect of improving the vertical temperature difference and further improving indoor comfort.

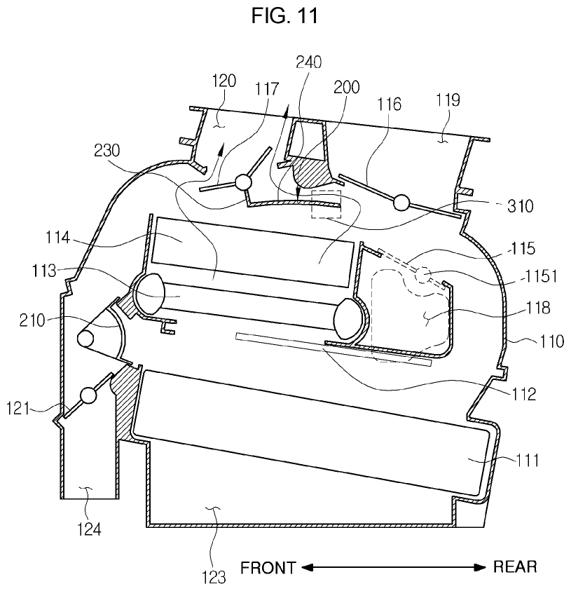

Meanwhile, further referring to FIG. 11, an air conditioner for a vehicle according to various exemplary embodiments of the present disclosure may include the hot air guide baffle 200 with yet another structure. In other words, the hot air guide baffle 200 includes a vertical partition wall portion 230 and a horizontal extended portion 240. The vertical partition wall 230 partitions the outlet of the defrost vent 120 in the front and rear direction of the vehicle. The horizontal extended portion 240 extends from the vertical partition wall portion 230 to the rear of the vehicle.

In other words, the vertical partition wall portion 230 is formed to extend in the vertical direction in the air conditioning case 110 and partitions between the front side and the rear side of the defrost vent 120. An upper end portion of the vertical partition wall portion 230 is positioned at a rotation shaft side of the defogging door 117. The horizontal extended portion 240 extends from the vertical partition wall portion 230 and is formed to block the rear side of the defrost vent 120. In other words, the horizontal extended portion 240 is formed to extend substantially in the horizontal direction from a lower end portion of the vertical partition wall portion 230 toward the face vent 119. The hot air guide baffle 200 including the vertical partition wall portion 230 and the horizontal extended portion 240 has substantially an “L” shape in a side cross-sectional view.

In a vent mode, the defrost vent 120 is closed, the face vent 119 is opened, and the floor vent 115 is closed. The hot air passing through the indoor condenser 113 and the electric heater 114 and the cooling air passing through the evaporator 111 are mixed and then discharged to the face vent 119.

In a bi-level mode, the defrost vent 120 is closed, the face vent 119 is opened, and the floor vent 115 is opened. The hot air passing through the indoor condenser 113 and the electric heater 114 and the cooling air passing through the evaporator 111 are mixed, and then some of the mixed air are discharged to the face vent 119 and the others are discharged to the floor vent 115.

In a floor mode or a mix mode, the defrost vent 120 is opened, the face vent 119 is closed, and the floor vent 115 is opened. The hot air passing through the indoor condenser 113 and the electric heater 114 is guided to the rear by the hot air guide baffle 200 and mixed with the cooling air passing through the evaporator 111, and then some of the mixed air are discharged to the defrost vent 120. In addition, the others are discharged to the floor vent 115. In the instant case, some of the hot air passing through the indoor condenser 113 and the electric heater 114 may move to the floor vent 115 through the hot air duct 300 to increase an amount of hot air.

In a defogging mode, the defrost vent 120 is opened, the face vent 119 is closed, and the floor vent 115 is closed. The hot air passing through the indoor condenser 113 and the electric heater 114 is directly discharged to the defrost vent 120. In the instant case, some hot air are blocked by the hot air guide baffle 200, but other vents are closed, and thus the overall amount of hot air discharged to the defrost vent 120 is not significantly affected.

In summary, because the air conditioner for a vehicle according to an exemplary embodiment of the present disclosure includes a structure in which the outlet of the defrost vent 120 and the heating heat exchanger are formed at the facing positions, it is possible to solve a problem in which a temperature at the defrost vent side increases when hot air is discharged directly through the defrost vent 120. To solve this problem, the air flow is guided to be changed so that the hot air passing through the heating heat exchanger is not directly discharged to the defrost vent 120 and may be bypassed to the cooling air flow path side.

In addition, the hot air ducts are added to the side surfaces of the air conditioning case to connect the heater outlet to the outlet of the floor vent to guide the hot air to the floor vent 118. Therefore, it is possible to prevent the situation in which the occupant's head gets hot by solving the problem of the vertical temperature difference, improving indoor comfort.

The hot air guide baffle 200 is formed to extend from the downstream side of the hot air flow path to a protruding pocket portion of the floor vent so that an end portion of the hot air guide baffle 200 and one side of the hot air duct 300 partially overlap. Therefore, the hot air passing through the heating heat exchanger is guided to the hot air duct 300 side, and the guided hot air may be smoothly guided to the floor vent 118 through the inlet, which is the coupling portion 310 of the hot air duct 300.

an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain predetermined principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An air conditioner apparatus for a vehicle, the apparatus comprising:
an air conditioning case in which an air flow path is formed;
a cooling heat exchanger; and
a heating heat exchanger,
wherein the cooling heat exchanger and the heating heat exchanger are provided sequentially on the air flow path of the air conditioning case in an airflow direction,
wherein a defrost vent, a face vent, and a floor vent are formed on the air conditioning case,
wherein a hot air duct configured to allow heated air at a downstream side of the heating heat exchanger to flow to an outlet of the floor vent is provided on the air conditioning case.

2. The air conditioner apparatus of claim 1,
wherein an internal flow path of the air conditioning case is formed in a vertical direction with respect to the ground so that the air flow path is directed from a downward direction, which is a direction of gravity, to an upward direction.

3. The air conditioner apparatus of claim 2,
wherein the cooling heat exchanger and the heating heat exchanger on the internal flow path include a structure that is sequentially disposed from the downward direction, which is the direction of gravity, to the upward direction in correspondence to the air flow path from the downward direction, which is the direction of gravity, to the upward direction.

4. The air conditioner apparatus of claim 3,
wherein the outlet of the floor vent is formed on a side surface of the air conditioning case, and
wherein the hot air duct is formed on the side surface of the air conditioning case to connect the downstream side of the heating heat exchanger to the outlet of the floor vent.

5. The air conditioner apparatus of claim 4, further including a hot air guide baffle in the air conditioning case configured to guide the heated air passing through the heating heat exchanger to a cooling air flow path side between the heating heat exchanger and the defrost vent.

6. The air conditioner apparatus of claim 5, wherein the hot air guide baffle blocks the heated air at the downstream side of the heating heat exchanger from being directly discharged to the defrost vent and guides the heated air to the floor vent.

7. The air conditioner apparatus of claim 5, wherein the hot air guide baffle is formed to extend to overlap a portion of the hot air duct.

8. The air conditioner apparatus of claim 5, wherein the hot air guide baffle includes:
a vertical partition wall portion partitioning an outlet of the defrost vent in a front and rear direction of the vehicle; and
a horizontal extended portion extending from the vertical partition wall portion to a rear of the vehicle.

9. The air conditioner apparatus of claim 5,
wherein the air conditioning case includes a defogging door configured to adjust an opening degree of the defrost vent, and
wherein the hot air guide baffle extends in a transverse direction between the heating heat exchanger and the defogging door.

10. The air conditioner apparatus of claim 9,
wherein a first end portion of the hot air guide baffle extends up to an internal wall of the air conditioning case and a second end portion extends toward a cooling air flow path, and thus an inside of the air conditioning case is covered at an opening of the defrost vent.

11. The air conditioner apparatus of claim 3,
wherein a floor door configured to adjust an opening degree of the floor vent is provided, and
wherein the hot air duct connects the downstream side of the heating heat exchanger to an upstream side of the floor door.

12. The air conditioner apparatus of claim 3, wherein the hot air duct is coupled to protrude laterally from a side surface of the air conditioning case, and an inclined surface is formed on a coupling portion between the hot air duct and the air conditioning case in the airflow direction.

13. An air conditioner apparatus for a vehicle, the apparatus comprising:
an air conditioning case in which an air flow path is formed;
a cooling heat exchanger; and
a heating heat exchanger,
wherein the cooling heat exchanger and the heating heat exchanger are provided sequentially on the air flow path of the air conditioning case in an airflow direction,
wherein a defrost vent, a face vent, and a floor vent are formed on the air conditioning case, and
wherein the air conditioning case includes a hot air guide baffle configured to guide heated air passing through the heating heat exchanger to a cooling air flow path side between the heating heat exchanger and the defrost vent.

14. The air conditioner apparatus of claim 13,
wherein an internal flow path of the air conditioning case is formed in a vertical direction with respect to the ground so that the air flow path is directed from a downward direction, which is a direction of gravity, to an upward direction.

15. The air conditioner apparatus of claim 14,
wherein the cooling heat exchanger and the heating heat exchanger on the internal flow path include a structure that is sequentially disposed from the downward direction, which is the direction of gravity, to the upward direction in correspondence to the air flow path from the downward direction, which is the direction of gravity, to the upward direction.

16. The air conditioner apparatus of claim 15,
wherein the air conditioning case includes a defogging door configured to adjust an opening degree of the defrost vent, and
wherein the hot air guide baffle is formed to extend in a transverse direction to block at least a portion between the heating heat exchanger and the defogging door.

17. The air conditioner apparatus of claim 15,
wherein the air conditioning case includes a defogging door configured to adjust an opening degree of the defrost vent, and
wherein the hot air guide baffle extends in a transverse direction between the heating heat exchanger and the defogging door, and a first end portion of the hot air guide baffle extends up to an internal wall of the air conditioning case and a second end portion extends toward a cooling air flow path, and thus an inside of the air conditioning case is covered at an opening of the defrost vent.
